(19) United States
(12) Patent Application Publication
(10) Pub. No.: US 2006/0089794 A1
(43) Pub. Date: Apr. 27, 2006

(54) Touch display fishing boat steering system and method

(76) Inventor: Louis DePasqua, Round Lake Beach, IL (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 10/971,466

(22) Filed: Oct. 22, 2004

(51) Int. Cl. G01C 21/34

(52) U.S. Cl. 701/208; 701/21; 340/995.19

(57) ABSTRACT

The present invention is directed towards an improved method for creating a navigational route by drawing a desired route on a screen in a continuous motion and utilizing a computer to generate GPS waypoints automatically. The desired navigation route of the boat is drawn onto the touch sensitive display predetermining the boat's steering course instantaneously. The system determines the steering course utilizing GPS/Loran longitude and latitude positions.

### CROSS-REFERENCE TO OTHER APPLICATIONS

This application incorporates by reference, and makes a part hereof, the following patent and applications: U.S. Pat. No. 5,859,517, issued Jan. 12, 1999, U.S. Utility patent application Ser. No. 10/779,330, filed Feb. 13, 2004, and U.S. Utility patent application Ser. No. 10/438,654, filed May 15, 2003, which is now abandoned.

### TECHNICAL FIELD

The present invention relates to a steering control system for a boat, such as a fishing boat, and more specifically to a technique for generating a navigation route using a touch screen computer display for use in steering a boat.

### BACKGROUND OF THE INVENTION

Trolling motors have been in use by fisherman for many years. These motors may be electric or gas powered and allows the fisherman to troll their boat quietly through the water in search of fish. Precise control of a boat is very important giving the angler an advantage necessary to locate specific areas in the water where fish may congregate. Many different techniques have been used over the years to control the navigation routes and steering of a trolling motor. These known steering techniques range from hand control to foot cable control, to voice control, to depth control, to compass and remote control. All of these steering systems must be constantly maintained in order to control the boat on its desired navigation routes.

A further technique for steering a trolling motor incorporates a satellite Global Positioning System. With the use of Global Positioning System (“GPS”) waypoints or longitude and latitude information, the user can navigate the boat on a desired route. For example, U.S. Pat. No. 5,884,213 to Carlson discloses a GPS for controlling the navigation of a fishing boat between waypoints representing successive positions around a navigation route. Several conventional input entry devices for generating waypoints or navigation routes may be utilized. These input devices may include the following: 1) A manual keypad or switch entry system that allows the user to enter in individual longitude and latitude positions one at a time to build a navigation route. 2) An electronic chart system that allows the user to download navigation routes that could include depth contour navigation. 3) A CD-ROM or non-volatile memory device that would allow the user to load predetermined waypoint navigation routes. 4) A method for recording in real time longitude and latitude waypoints into a memory device while the user navigates the boat. These recorded navigation routes then can be repeated in forward or reverse.

Another example of a GPS waypoint navigational system is being sold by MAPTECH Inc. The MAPTECH i3 product is a touch screen GPS waypoint navigational system geared for larger boats. The i3 system is not setup to be used with small fishing boats using bow mount style small electric trolling motors. The i3 system allows the skipper of the boat to enter in the discrete navigational GPS waypoints by touching and releasing their finger on the i3 display. The touch screen display may be viewed as an underwater topographical map or a land map. In order to create the desired navigational route, waypoints are entered in discrete intervals by touching and releasing the display. When multiple waypoints are entered, the i3 must connect the discrete waypoints together with lines that display the navigational route on the screen. With this system the user must manually enter in waypoints one at a time to create the complete navigational route.

The present invention is provided to solve these and other problems.

### SUMMARY OF THE INVENTION

The present invention is directed towards an improved method for creating a navigational route by drawing a desired route on a screen in a continuous motion and utilizing a computer to generate GPS waypoints automatically. The system incorporates a touch screen LCD/CRT display to be used to hand draw virtual continual navigation routes across an image that may include grids, and or land and or topographical water maps. For example, if a user would like the boat to steer in a circle, the user draws a circle on the display screen in a single motion and the computer will automatically generate the waypoints necessary to navigate the circle.

A further embodiment of the present invention provides a method for drawing navigational routes utilizing a grid shown on the touch display screen. The grid represents the dimensional area of water surrounding the boat. Full navigation routes could be entered into the boat's navigational system by drawing the desired route the user would like the boat to travel. The grid steering system may further be utilized with the use of topographical and land water maps. In this manner, the user can approximate the navigational route based upon visual approximation grids, and the water around the boat or with respect to the topography in the area.

The touch sensitive LCD/CRT display is part of the computer system. The display may be mounted in a handheld wireless computer, or may be a component of a fishing boat's depth sonar system. The user will have several options for hand drawing the desired navigational route for the trolling motor driven fishing boat. The touch sensitive display image can be configured in several different ways including grids, topographical depth water maps, or land maps.

When using the grid steering method, square grids will be shown on the display screen. The grids represent the dimensional area around the boat. The grids can be adjusted to represent varying dimensional areas around the boat. When inputting the desired navigational route the user presses their finger or a contact pen, such as a stylus, against the display and moves an icon around the grid patterned display. For example, if each square grid is equal to ten feet across, and the user would like the boat to travel 30 feet straight ahead, and subsequently turn 90 degrees and go 20 feet to the left, the user would draw a line on the screen three grids straight ahead and then two grids to the left. At that point the user would see an icon located at the end of the lines they just had drawn. Preferably, an audible click sound also can be heard from the hand held computer as the user moves the finger or pen across any grid edge. This helps the user approximate distance as they visually look ahead on the water.

To start the boat on its hand drawn navigational route the user presses an activation button. Upon activation the boat would calculate its current GPS waypoint position (longitude and latitude). Based upon a single waypoint reading and the compass heading, all of the necessary waypoints can be virtually generated by the computer grids to complete the hand drawn virtual navigational route dawn on the display. The navigation system would start driving the boat to the desired waypoint locations with the use of the boat's propulsion and steering system. The boat's navigation system may include an electric trolling motor a thruster or gas combustion engine. The icon position shown on the display moves as the boat travels along the hand drawn route, showing the user the boat's current position. The grid steering method allows the user to steer the boat based upon a visually drawn course and allows the user to approximate the boat's navigation route with virtual visual grids on the touch display screen.

In addition to the grid steering method, visual depth or land maps containing GPS waypoint information could be displayed on the touch sensitive display screen, allowing the user to simply hand draw in their desired navigation route based upon water depth and or shore maps. This allows the user additional flexibility and predictability as they hand draw in the desired navigation route. This steering method would operate the same as the grid steering method except the waypoint information would be based upon waypoint information provided by a preloaded visual topographical water/depth and land maps. Once the hand drawn navigation route is drawn on the display screen the computer automatically generates the waypoints necessary to navigate the boat in the pattern drawn on the screen.

### BRIEF DESCRIPTION OF THE DRAWINGS

FIG. 1 is a diagram showing a boat with a bow mounted trolling motor.

FIG. 2 is a block diagram of the trolling motor and GPS control circuitry.

FIG. 3 is a block diagram of the electronic remote circuitry.

FIG. 4 is a diagram showing the touch sensitive display in a grid view.

FIG. 5 is a diagram showing the touch sensitive display in shoreline and water depth view.

### DETAILED DESCRIPTION

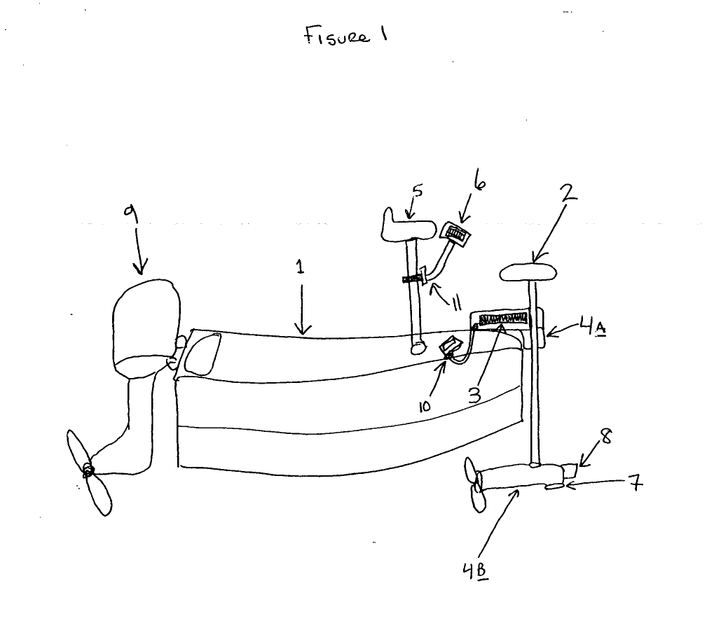

FIG. 1 shows a boat 1 having a bow mount electric trolling motor 2. The trolling motor includes a GPS receiver control system 3 mounted on the lower side of the trolling motor 2. The GPS receiver control system 3 communicates with a wireless touch sensitive display controller 6 through a radio frequency (R.F.) receiver. The GPS receiver control system 3 performs control functions for the an electronic driven steering motor 4a, a propeller motor 4b, including speed control, sonar obstacle sensing 7, 8, and GPS waypoint navigation management. The GPS receiver control system 3 further may control a combustion/thruster steering engine 9, and a touch display/sonar 10 for additional sonar/hand drawn GPS navigation display. In operation, the operator of the boat may sit at a front seat 5, having a remote holder devise 11 used to hold the touch display unit 6. Additionally, the operator may remove the wireless remote display 6 and move freely around the boat 1.

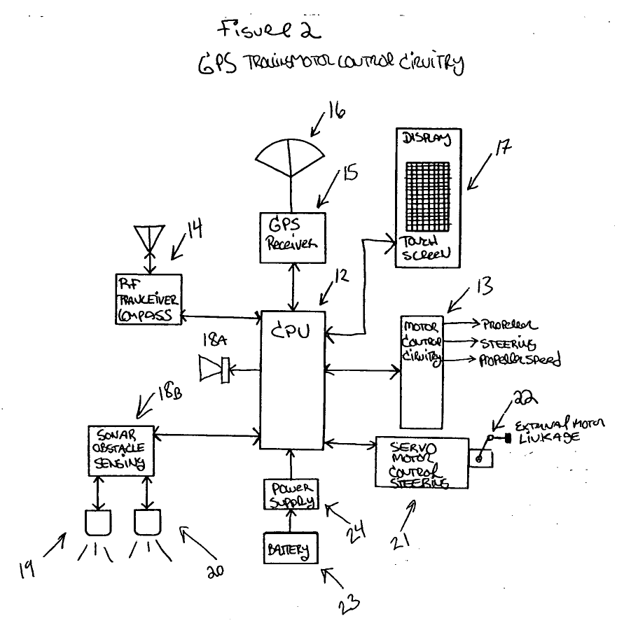

FIG. 2 is a block diagram of the GPS receiver control system 3. The system 3 comprises a processor 12 connected to the trolling motor control circuitry 13. The trolling motor control circuitry 13 controls the trolling motor's propeller mechanism and steering mechanism. A GPS antenna 16 is connected a GPS/Compass module receiver 15. The GPS antenna 16 receives longitude/latitude and compass data signals from satellites and the earths magnetic field and transmits this GPS data to the GPS/Compass module receiver 15. The processor 12 utilizes the GPS data to navigate the boat on its desired route. The processor 12 automatically generates GPS waypoints based upon the GPS data and the hand drawn navigational routes entered into an interactive touch screen display 17.

A user may utilize the touch screen display 17 to draw a continuous navigational route, which can be subsequently inputted into the system. The display 17 may include a grid showing the dimensional area surrounding the boat. In this manner, the user may draw continuous navigational routes on top of a visual location map, which can be shown on the display 17. This may assist in (continuously) entering a route into the display, thereby avoiding land and/or other obstacles, and/or creating a route which is advantageous for the activity being performed on the boat, such as fishing. The display 17 may further be used to display underwater standard sonar display (charts), as known to one of ordinary skill in the art. These charts may also be used to avoid land and/or other obstacles, and/or creating a route which is advantageous for the activity being performed on the boat, such as fishing.

An audio transducer 18a may be used as sound audible indicators in the system. One such audible indicator may be a click-type noise that can be heard as the user draws their continuous navigational route across a grid line on the touch screen display 17. Further, a sonar obstacle sensing circuitry 18b may be connected to transducers 19, 20 for sending sonar signals below, ahead, and behind the boat. These sonar signals may be used during a navigational route to indicate an obstacle or shoreline in the vicinity of the boat. If the processor 12 senses an obstacle or shoreline in the vicinity of the boat, the system may automatically alter the navigational route or audibly and/or visually indicate the presence of the obstacle and provide information relating to the obstacle. Thus, obstacle information may further be used as an automatic safety shut down feature, which shuts the trolling motor off. A servo motor control 21 may be used as a alternate steering control mechanism for controlling the steering direction of a combustion or thruster engine on larger style boat. A linkage 22 may connect to the engine's steering linkage.

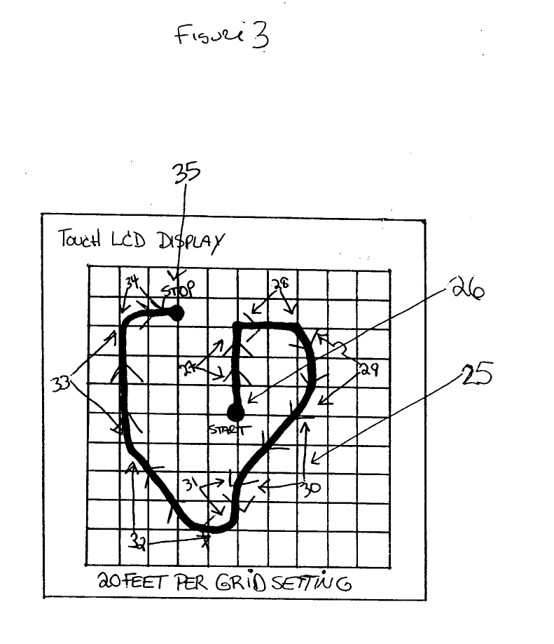

An R.F. transceiver circuitry 14 serves as a wireless link allowing for communications to a wireless remote touch entry display to be used for entering in navigational routes remotely as with the hand remote as shown in FIG. 3. A battery 23 is used to power the control circuitry and connects to the power supply regulation circuit 24 for providing regulated voltage to the system.

FIG. 3 represents a system using a grid steering method and shows a grid image 25 on the display 17. A user may input a continuous navigational route on the display 17 showing the grid image 25. Unlike a visual topographical or land/shore map, no preset waypoint information is necessary to formulate the navigational route. The grid system formulates the navigational route based upon the boat's current GPS start position and magnetic heading. Knowing the boat's starting position, longitude/latitude, and compass heading in conjunction with the user drawn navigational route overlapping the grid image 25 permits a generation of the navigational route and waypoints. Grid image 25 represents the dimensional area surrounding the boat. However, the dimensional area represented by each grid may be adjusted. For example, the dimensional area of the grid 25 in FIG. 3 is set to 400 square feet per grid. The grid is a square and thus represents 20 feet horizontally and 20 feet vertically. Knowing the dimensional area of each grid as compared to the boat size, a user can draw an approximated boat navigational route.

To start a new navigation route, a user selects a new route activation button 36. The grid 25 on the display 17 shows a start point image 26 representing the boat. Preferably, the start image point 26 is in the center of the display 17. The user draws the continuous navigational route on the touch screen 17 by pressing their finger or stylus in the center of the screen. In a single continuous motion, the navigation route can be drawn on the touch screen, as seen in FIG. 3. As the navigation route is being drawn on the touch screen, the processor 12 records the travel distance and direction based on the touch screens positions with reference to the pixel grid locations on the display. This touch screen travel information can be utilized by the processor 12 to automatically generate the necessary waypoints needed to complete the hand drawn navigational route, either in real time or at a later time based on stored data from the hand drawn route received by the display interface. Thus, the processor 12 detects the continuous navigational route drawn on the touch screen 17 in real-time, and can interpret this information in real time, as well, or at a later time. Preferably, the waypoints are generate immediately or in real time. The processor 12 will record the travel distance and direction based on the sampling pixel grid location information, which in one embodiment can be done at defined time intervals.

For example, FIG. 3 shows a hand drawn navigational route 25. Following the route, the boat will travel 60 feet straight ahead 27, then turn 90 degrees and travel 40 feet 28, then turn 45 degrees and travel on a curved path for 60 feet 29, and turn 45 degrees and travel 40 feet 30, and turn 45 degrees and travel 40 feet 31, then turn 45 degrees and travel 80 feet 32, then turn 45 degrees and travel 80 feet 33, and turn 45 degrees and travel 40 feet 34, where the boat will stop 35.

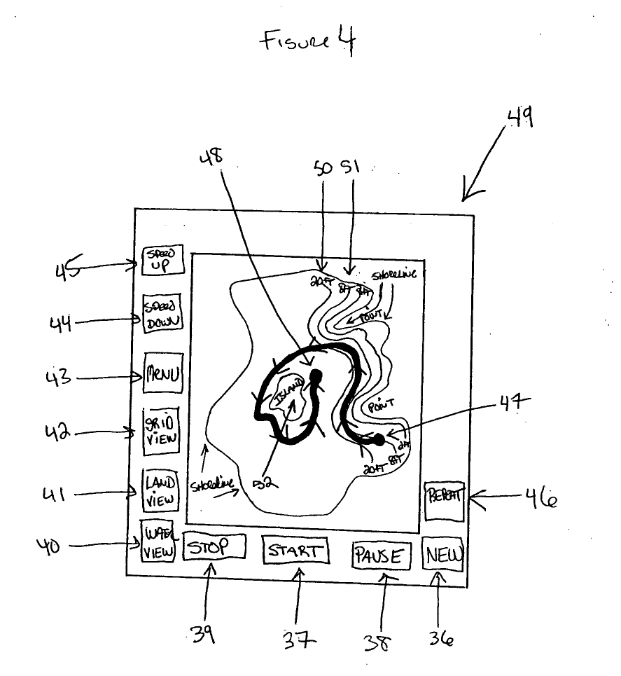

As the user draws the desired navigational route on the touch screen display an audible indicator may be heard from speaker 18a as each grid point or line is crossed. This may assist in looking at the water and drawing the visual navigation route. Once the desired navigational route is entered, the user will simply press the start navigational button 37 as shown in FIG. 4. The processor 12 will direct control signals to the propeller and steering mechanisms to propel and steer the boat on a navigational route based upon the GPS waypoints that were generated by the hand drawn touch screen navigation route.

FIG. 4 provides an additional embodiment showing a method for hand drawing in a navigational a route on a touch screen display 49. The drawing method is similar to the FIG. 3 grid image 25, but further displays an image of a topographical water and land map. It should be noted that the topographical water and land map may be superimposed over the grid 25 or be displayed without the grid 25. The system permits the user to draw a continuous navigational route in reference to lake, underwater and land maps containing waypoint information stored in memory. As with the previous embodiment, the user draws a continuous navigation route onto the touch sensitive screen. The user may view the navigational route on touch display 49 and select the desired hand drawn route based on depth patterns as shown on the display.

As seen in FIG. 4, the navigational route starts at 47, and travels along a depth of 8 feet 51, and crosses over the 20 foot mark at 50. The navigational route continues toward an island 52, and then continues around the island until it reaches its stop point 48. After the route is drawn on the touch screen display, the processor generates waypoints from the preloaded lake, underwater and land maps that have reference waypoint information stored in memory. The processor generates navigational waypoint data based upon the hand drawn navigational route layered across a visual underwater land map containing preloaded waypoints. It should be noted that the accuracy or number of the waypoints generated may be adjusted as needed with the system parameters on the menu page 43.

The user may draw a new continuous navigational route by pressing the new button 36 thereby clearing any old display navigational routes. Pressing the view selection buttons 40, 41, 42, on the display permits the user to change the operational mode or views from grid to land or water depth. Once a navigational route is drawn, the user may activate the system by pressing button 37. Once the system is running the system can be paused at any time by pressing the pause button 38. The boat will be held in the same spot until the pause button 38 is pressed again to continue the navigational route. The stop button 39 is used to stop the boat from moving. During operation, pressing the start button restarts the navigational route from the beginning. The repeat button causes the boat to travel back and forth from start to finish and finish to start. The menu button allows the user to set system parameters. The speed up 45 and speed down 44 buttons allow the user to adjust the boat speed during the navigational route.

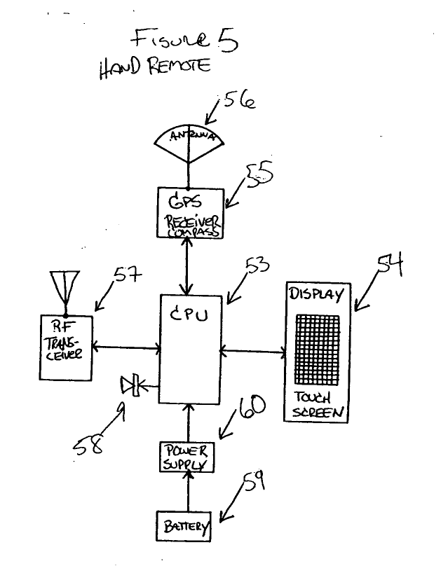

FIG. 5 shows a block diagram of an electronic wireless touch remote display that may be in the form of a standard hand held PDA computer (which may have also have installed GPS software, GPS hardware interface, RF software, and/or a RF hardware interface) that can use downloadable navigational software for operation. The display on the remote device operates similar to the display 17 as previously described with respect to FIG. 2. The software allows the user to hand draw a continuous navigation route on the touch screen display of the remote device. The navigation route may overlay an image showing topographical/sonar water/land maps having predetermined waypoints or grids that allow for approximated hand drawn navigational routes. The remote display permits the user the freedom to walk around the boat and enter in hand drawn touch screen continuous navigational routes. These navigational routes or waypoints generated by a processor 53 may be sent via R.F. communications to the trolling motor controller that will then navigate the boat based upon the hand drawn continuous navigational route. It should be understood that the routes may be entered according to the present invention, while a user is on a boat or elsewhere. Such entered routes may be stored in memory, named, and later recalled for use in actual navigational control of boat or other vehicle. Thus, a standard PDA, such as the PDA described herein, can be used as the touch display 54, and otherwise perform at least all the functions of the touch display 54. A PDA, such as one with a GPS software and hardware interface, can also perform the functions of the GPS receiver 15 (and 16), and other functions of the components of FIGS. 2 and 5.

The processor 53 controls operations of the remote system. Navigational waypoints generated by the processor 53 may be directly sent to the trolling motor control circuitry for navigational control. In an alternate embodiment, the wireless remote device may be used to directly control the navigation of the boat through wireless steering and speed controls. In this embodiment, the GPS receiver and touch display 17 are not needed for the trolling motor control circuit 15. Rather, touch display 54 is used to enter hand drawn navigational routes in a manner identical to the operation described above for the touch display 17. GPS receiver antenna 56 passes satellite signals to the GPS/Compass receiver 55, which operates in a manner identical to the GPS/Compass receiver of the previous embodiment. The GPS/Compass receiver 55 receives longitude/latitude satellite information and compass headings to formulate and manage navigational routes. R.F. transceiver 57 is used to communicate with the trolling motor controller transceiver 14. The transceiver 57 sends navigational route waypoints information drawn on touch display 54. The R.F communications permits the user to control other manual functions of the trolling motor such as steering and speed and can further be used to pass sonar depth information through a sonar circuit 18b. Audio transducer 58 is used for audible indicators in the same manner as the audio transducer of FIG. 2. Battery 59 provides power to the power regulation circuit 60 used to regulate the proper voltage to the system.

While specific embodiments have been illustrated and described, numerous modifications come to mind without significantly departing from the spirit of the invention and the scope of protection is only limited by the scope of the accompanying claims.

What is claimed is:

1. An electronic steering control system comprising:
an input device for generating continuous navigational route data;
a processor coupled to the input device for generating navigational waypoint data corresponding to the continuous navigation route data; and
a motor coupled to the processor for navigating a vehicle responsive to the navigational waypoint data.

2. The electronic steering control system of claim 1 further comprising a global positioning system receiver coupled to the processor for providing the processor with global positioning system data.

3. The electronic steering control system of claim 1 further comprising a obstacle sensing module for providing an alarm indicating the presence of an obstacle.

4. The electronic steering control system of claim 1 wherein the input device is a touch screen display that provides for entering a continuous navigational route.

5. The electronic steering control system of claim 4 wherein the touch screen display provides a grid image for entering the continuous navigation route.

6. The electronic steering control system of claim 4 wherein the touch screen display provides a topographic map image for entering the continuous navigation route.

7. The electronic steering control system of claim 4 further comprising a navigation system wherein the touch screen display provides an indicator representative of vehicle position.

8. The electronic steering control system of claim 4, wherein the continuous navigational route has a graphical representation.

9. A method for generating a navigation route for a vehicle, the method comprising the steps of:
receiving continuous navigational route data;
generating navigational waypoint data corresponding to the continuous navigation route data; and,
generating at least one motor control signal responsive to the navigational waypoint data.

10. The method of claim 9, further comprising the step of entering a continuous navigation route.

11. The method of claim 9, wherein the continuous navigation route is entered on a display providing a grid image representing a dimensional area surrounding the vehicle.

12. The method of claim 9, wherein the continuous navigation route is entered on a display providing a topographical map image representing the area surrounding the vehicle.

13. The method of claim 9 wherein the navigational waypoint data is generated utilizing the continuous navigation route data and global positioning system data.

14. The method of claim 9 further comprising the step of navigating the vehicle along a route representative of the continuous navigation route data.

15. A method for generating a navigation route for a vehicle, the method comprising:
receiving navigational waypoint data generated utilizing continuous navigation route data and global positioning system data; and
generating at least one motor control signal responsive to the navigational waypoint data.

16. The method of claim 15, wherein the navigational waypoint data is received from an wireless touch remote controller.

17. The method of claim 16, wherein the wireless touch remote controller generates at least one motor control signal.

18. The method of claim 16, further comprising the step of entering a continuous navigation route on a display coupled to the wireless touch remote controller.

19. The method of claim 18, wherein the display provides a grid image representing a dimensional area surrounding the vehicle.

20. The method of claim 18, the display provides a topographical map image representing the area surrounding the vehicle.

21. The method of claim 15 further comprising the step of navigating the vehicle along a route representing the continuous navigation route data.

22. A system for controlling the navigation of a vehicle having a trolling motor, the system comprising:
a receiver component for receiving continuous navigation route data;
a processor coupled to the receiver component for generating navigational waypoint data utilizing continuous navigation route data and global positioning system data.

23. The system of claim 22 further comprising a motor controller coupled to the processor for generating motor control signals responsive to the navigational waypoint data.

24. he system of claim 22 further comprising a global positioning system receiver coupled to the processor for providing global positioning system data.

25. The system of claim 22 further comprising an obstacle sensing module for providing an alarm indicating the presence of an obstacle.

26. The system of claim 22 wherein the continuous navigation route data is received from a wireless remote touch remote controller.

27. The system of claim 22 further comprising a touch screen display for entering a continuous navigational route and creating continuous navigational route data.

28. The system of claim 22 wherein the touch screen display provides a grid image for entering the continuous navigation route.

29. The system of claim 22 wherein the touch screen display provides a topographic map image for entering the continuous navigation route.

30. The system of 22 further comprising a navigation system wherein the touch screen display provides an indicator representative of vehicle position.
